(19) United States
(12) Patent Application Publication
(10) Pub. No.: US 2014/0311032 A1
(43) Pub. Date: Oct. 23, 2014

(54) STEP PLATE MECHANISM FOR DOOR OPENING AND CLOSING DEVICE

(71) Applicants: Yasuo Nakano, (US); miimo LTD., Tokyo (JP)

(72) Inventor: Yasuo Nakano, Fukushima (JP)

(73) Assignee: miimo LTD., Tokyo (JP)

(21) Appl. No.: 14/116,819

(22) PCT Filed: May 11, 2012
(86) PCT No.: PCT/JP2012/062212

§ 371 Date: Apr. 22, 2014

(30) Foreign Application Priority Data
May 11, 2011 (JP) 2011-106537
May 11, 2011 (JP) 2011-106538

(51) Int. Cl. E05F 13/02; E05F 11/54

(52) U.S. Cl. CPC E05F 13/02; E05F 11/54
USPC 49/272; 49/273

(57) ABSTRACT

To further reduce the space required for installation, and to facilitate installation of a device for opening and closing a door by the stepping force of a pedestrian, the door-opening/closing device includes a step plate (2) provided with multiple bearings, a link (5) whose one end is coupled to a bearing (6) of the step plate (2), with the bearing (6) disposed in a metal part fixed on the floor and coupled to the other end of the link (5). The step plate (2) remains horizontal when stepped on, and moves downward in an arcuate manner in the direction in which the pedestrian is walking. The door (1) is opened and closed using this displacement (i.e., the step plate's downward movement) as a motive force. The return mechanism of the step plate (2) is composed of a link extender in which the other end side of the link (5) is extended in the direction opposite from the step plate (2), and a weight (7) that is axially supported on the extending-end part of the link extender. When a pedestrian steps on the step plate (2) the weight (7) rises and the step plate (2) moves downward; and, when the pedestrian steps off the step plate (2), the weight (7) moves downward due to its own weight and causes the step plate (2) to rise.

### FIELD OF THE INVENTION

The present invention relates to a step-plate mechanism for a door-opening/closing device, and more precisely, to a step-plate mechanism that is powered by the stepping force of a pedestrian, wherein, after the pedestrian has passed, a return mechanism inside the step-plate mechanism closes the opened door.

### BACKGROUND OF THE INVENTION

In general, a conventional door-opening/closing device operated electrically does not respond if a pedestrian approaches the device too slowly. If a pedestrian stops walking, the device closes the door even if the pedestrian is in the area within which the device senses the presence of a human (hereinafter “device's detection area”). Also, if there is a power outage, the door that the device is to operate, together with the device's drive unit, needs to be moved by human power so as to open or close the door, which requires a large amount of human force. In order to prevent such operational failure and the resulting need for human force to be applied, a conventional device requires not only a source of primary electricity but also a source of backup electricity. In addition, a conventional device has many disadvantages, such as the adverse effects on human bodies and on precision equipment near the device of the electromagnetic waves used for the device's sensor.

In order to eliminate the above-mentioned disadvantages, many door-opening/closing devices that do not use electricity but use the potential energy obtained by the downward movement of a step plate stepped on by a pedestrian have been invented. In many of these devices, a door opening/closing mechanism is disposed on the floor, as well as in a door pocket and/or a transom, and therefore such a device requires a large space.

One example of the prior art is the door-opening/closing device described in Patent Document 1 (see FIG. 8). This door-opening/closing device has a mechanism such that a portion—specifically the portion that is immediately beneath a door—of a step plate is raised, and such that the front and rear ends—as seen by an pedestrian—of the step plate are affixed to the floor by hinges. The force by which the step plate is restored to its original raised position after having been stepped on is interlocked with a door-closing force. But this has the disadvantage of requiring a large space in the door's transom. Another disadvantage is that the acting force obtained from the stepping force varies depending on the specific position stepped on by a pedestrian.

The door-opening/closing device described in Patent Document 2 (see FIG. 9) has no mechanism in the door's transom, but it has a large mechanism in the door pocket. This large space needs to be taken into consideration when designing a building.

### PRIOR-ART DOCUMENTS

### Patent Documents

Patent Document 1: Japanese Unexamined Patent Application Publication No. H7-208016

Patent Document 2: Japanese Utility Model Application No. 2005-7550

### BRIEF DESCRIPTION OF THE INVENTION

### Problems to be Solved by the Invention

A conventional door-opening/closing device that is operated by the weight of a pedestrian includes a step-plate mechanism on the floor and a drive mechanism in a door pocket and/or a door's transom. Because such mechanisms require large spaces, it is difficult to install a conventional door-opening/closing device in a building. Accordingly, one objective of the present invention is to provide a step-plate mechanism for a door-opening/closing device that is operable in a smaller space, is easy to install, and wherein the thickness of the step-plate mechanism is reduced and there is included a self-return configuration in which a step plate moves downward due to the load of a pedestrian and automatically rises back after the pedestrian passes.

### Means for Solving the Problems

A (the first) step-plate mechanism for a door-opening/closing device according to the present invention is described as:
a step-plate mechanism for a door-opening/closing device that is powered by the downward displacement of a step plate due to the stepping force of a pedestrian, with a step plate being disposed on the floor at both the front and back sides of a door (front and back as seen by a pedestrian);
wherein a return mechanism is provided to bias the step plate, which moves downward due to the stepping force of the pedestrian, to return to its original position after the pedestrian passes.

Another (the second) step-plate mechanism for a door-opening/closing device according to the present invention is described as:
a step-plate mechanism according to the above first step-plate mechanism;
and wherein the step-plate mechanism further includes
   the step plate having plural bearings,
   multiple links, one end of each of which is coupled to one of the bearings of the step plate, and
   bearings, disposed in a metal part fixed on the floor, each of which is coupled to the other end of each of said links;
wherein the step plate, while remaining horizontal, moves downward and arcuately in the direction in which the pedestrian is moving; and
wherein the return mechanism biases the links, whose angles have been displaced in the downward direction due to the load of the pedestrian, to return to their original angles.

Another (the third) step-plate mechanism for a door-opening/closing device according to the present invention is described as:
a step-plate mechanism according to the above second step-plate mechanism;
and wherein two step plates are provided, one step plate having an interlock guide, and the other step plate having an interlock-guide receiving member that is slidably connected to the interlock guide; and
wherein, when the one step plate moves downward in a constant displacement, the other step plate also moves downward in a line-symmetric, constant displacement with the door as a symmetrical axis.

Another (the fourth) step-plate mechanism for a door-opening/closing device according to the present invention is described as:
a step-plate mechanism according to the above second or third step-plate mechanisms;
and wherein the return mechanism comprises a link extender in which the other end of each of said links is extended in the direction opposite from the step plate, and a weight that is axially supported on the end of the extended part of the link extender; and
wherein the weight rises when a pedestrian steps on the step plate, causing the step plate to move downward, and then moves downward due to its own weight and causes the step plate to rise when the pedestrian steps off the step plate.

Another (the fifth) step-plate mechanism for a door-opening/closing device according to the present invention is described as:
a step-plate mechanism according to any one of the above first, second, or third step-plate mechanisms;
and wherein the return mechanism includes bearings mounted to metal parts, fixed on the floor, of the step plate, and a torsion spring mounted coaxially with one of the bearings to a shaft disposed in the metal parts; and
wherein the torsion spring accumulates a biasing force when a pedestrian steps on the step plate, causing the step plate to move downward, and the torsion spring releases the biasing force to cause the step plate to rise when the pedestrian steps off the step plate.

Another (the sixth) step-plate mechanism for a door-opening/closing device according to the present invention is described as:
a step-plate mechanism according to any one of the above first to third step-plate mechanisms;
and wherein the door is an overhung door whose upper end is slidably hung on an overhung-door rail, and the overhung-door rail is inclined downward in either the door's opening direction or the door's closing direction.

### Effects of the Invention

Because a step-plate mechanism for a door-opening/closing device according to the present invention does not need large spaces in the floor at the front and back of a door, a door pocket, and/or a transom, it is easy to install.

### BRIEF DESCRIPTION OF THE DRAWINGS

FIG. 1 is an external view of a door-opening/closing device using a step-plate mechanism according to the present invention (Embodiment 1).

FIG. 2 is a front view of a step-plate mechanism for a door-opening/closing device according to the present invention (Embodiment 1).

FIG. 3 is a front view of a step-plate mechanism for a door-opening/closing device according to the present invention when a pedestrian steps on the step plate (Embodiment 1).

FIG. 4 is a front view of a step-plate mechanism for a door-opening/closing device according to the present invention (Embodiment 2).

FIG. 5 is a plan view of a link and torsion spring of a step-plate mechanism for a door-opening/closing device according to the present invention (Embodiment 2).

FIG. 6 is an external view of a door-opening/closing device using a step-plate mechanism for a door-opening/closing device of a modification of the present invention.

FIG. 7 is an external view of a door-opening/closing device using a step-plate mechanism for a door-opening/closing device of another modification of the present invention.

FIG. 8 is an example of the door-opening/closing device disclosed in Japanese Unexamined Patent Application Publication No. H7-208016.

FIG. 9 is an example of the door-opening/closing device disclosed in Japanese Utility Model Application No. 2005-7550.

### EMBODIMENTS FOR CARRYING OUT THE INVENTION

The present invention's step-plate mechanism for a door-opening/closing device will now be explained in detail with reference to the drawings. The present invention's step-plate mechanism for a door-opening/closing device does not need large spaces of the floor at the front and back sides of a door, nor a door pocket, nor a transom, and it is easy to install.

### Embodiment 1

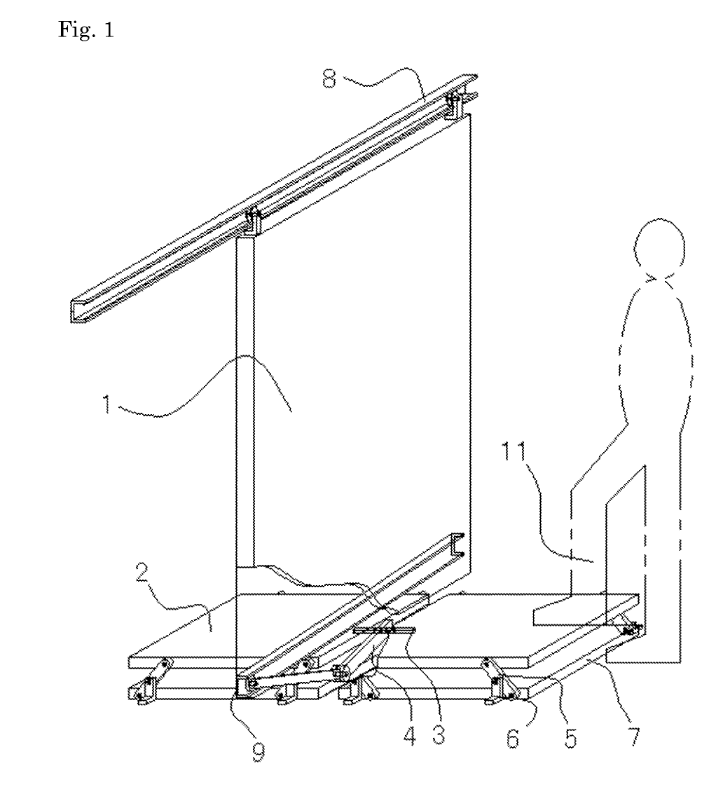

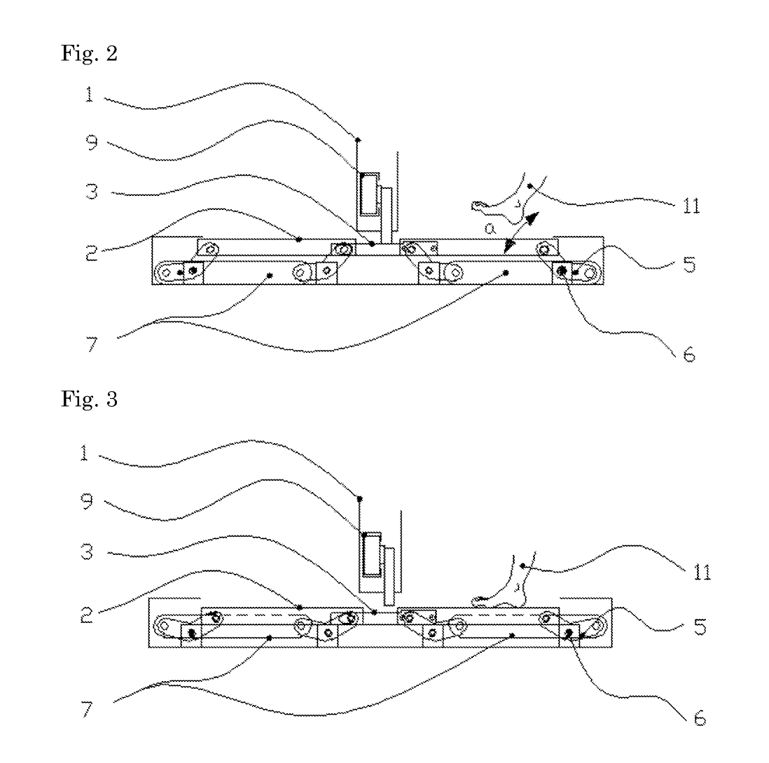

Embodiment 1 of the present invention will be explained with reference to FIGS. 1-3. FIG. 1 shows the Embodiment combining a step-plate mechanism (S1) comprising a return mechanism using weights 7, step plates 2, an interlock guide 3, links 5, and bearings 6; and a door-opening/closing mechanism (D) comprising a door 1, a drive arm 4, an overhung-door rail 8 and a guide 9.

The step plate 2 in FIG. 1 moves downward as shown in FIG. 3 by the stepping force of a pedestrian coming from the right side in the figures, and that force is transferred to the interlock guide 3, the drive arm 4, and the door-opening/closing mechanism (D). At the same time, the links 5 raise the weights 7 that are mounted to the link extenders (reference number omitted) that extend in the direction opposite from the step plate 2, with the bearings 6 of the metal parts fixed on the floor serving as fulcrum points.

The step plate 2 is raised to return to its original position by the weights 7 moving downward after the pedestrian passes.

If the step-plate mechanism for a door-opening/closing device of the present invention is used in Embodiment 1, there is no need for a mechanism in a door pocket, because the guide 9 that is enclosed in a lower housing works as a drive mechanism. That is, no parts are necessary other than the door 1, the overhung-door rail 8 above the door, and the step-plate mechanism. Here, the overhung-door rail 8 is inclined downward to either the opening direction or closing direction of the door 1. Because the upper end of the door 1 is hung slidably to the overhung-door rail 8, the door 1 can be opened and closing easily.

Because the returning energy is obtained by not mechanical force such as a spring but by weights 7, the performance of which does not change, the power for returning a door is stable for a long time, and the need for inspection and maintenance is reduced.

### Embodiment 2

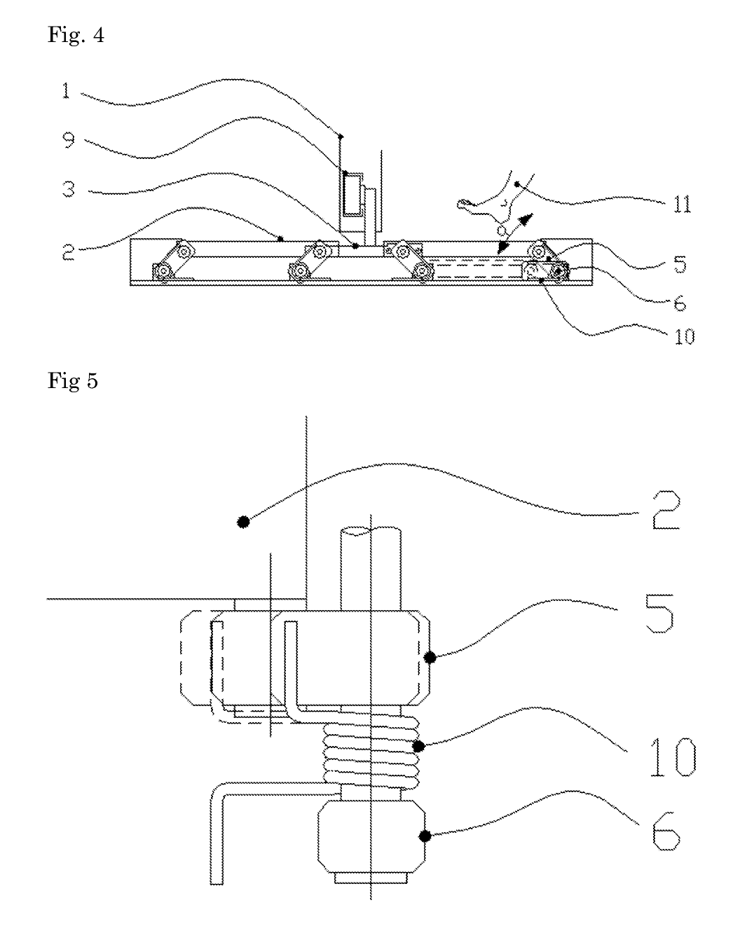

There now will be explained in detail with reference to FIGS. 4 and 5 an embodiment of the present invention that combines the step-plate mechanism (S2) for a door-opening/closing device that uses torsion springs 10 as the return mechanism, and that comprises a step plate 2, an interlock guide 3, links 5 and bearings 6; and the door-opening/closing mechanism (D) that comprises a door 1, a drive arm 4, an overhung-door rail 8, and a guide 9.

In the present invention's step-plate mechanism for a door-opening/closing device using, as a return mechanism, torsion springs 10, as shown in FIG. 5, instead of the weights 7 of the step-plate mechanism described above, the step plate 2 is returned to its original position by the repelling force of the torsion springs 10, which are mounted coaxially with the bearings 6 disposed in the metal part fixed on the floor, with one end of each torsion spring 10 being fixed to the metal part fixed on the floor, and the other end being fixed to the link 5.

In this way, because a step-plate mechanism having links 5, torsion springs 10, and bearings 6, etc. is disposed on both sides of the step plate 2 and the links 5, the torsion springs 10, and the bearings 6, etc. are not disposed beneath the step plate 2, the step plate 2 can move downward to the bottom of the step-plate mechanism when a pedestrian steps on the step plate 2. Accordingly, the thickness of the step-plate mechanism can be reduced.

Because the thickness of the step-plate mechanism is reduced, it is not necessary to dig a hole in the floor, and if the drive mechanism of Embodiment 2 is used, no special installation work is necessary in erecting a building other than installing an inclined overhung-door rail 8.

In the above embodiment, the step plate 2 remains horizontal and moves downward arcuately in the direction in which the pedestrian is walking, by coupling the bearings 6 of the step plate 2 and the bearings 6 that are disposed in the metal part fixed on the floor by the links 5. However, the present invention can be applied to other types of step-plate mechanisms, using levers or the like, for a door-opening/closing device powered by the downward movement of a step plate 2.

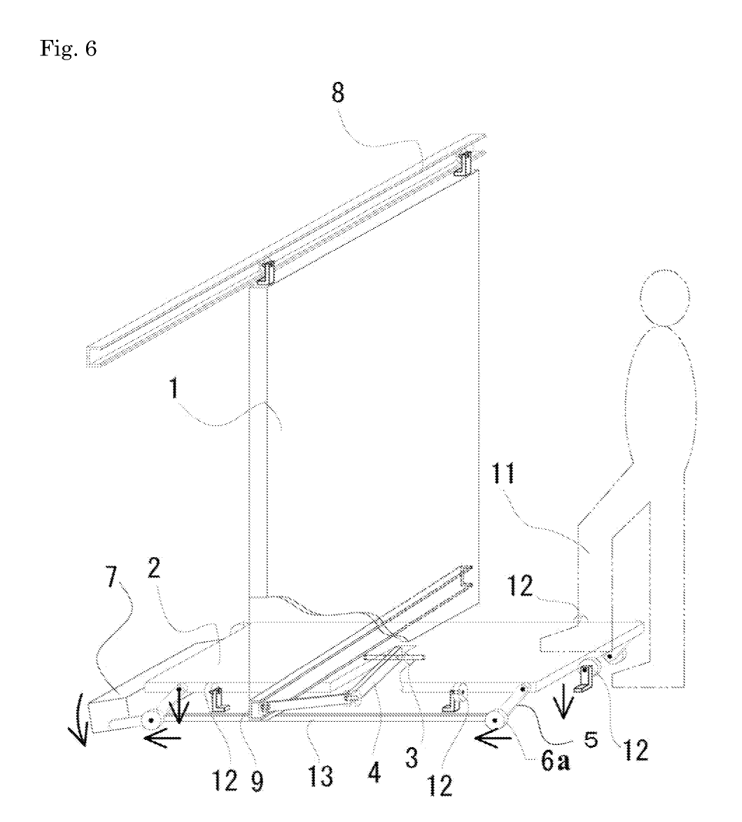

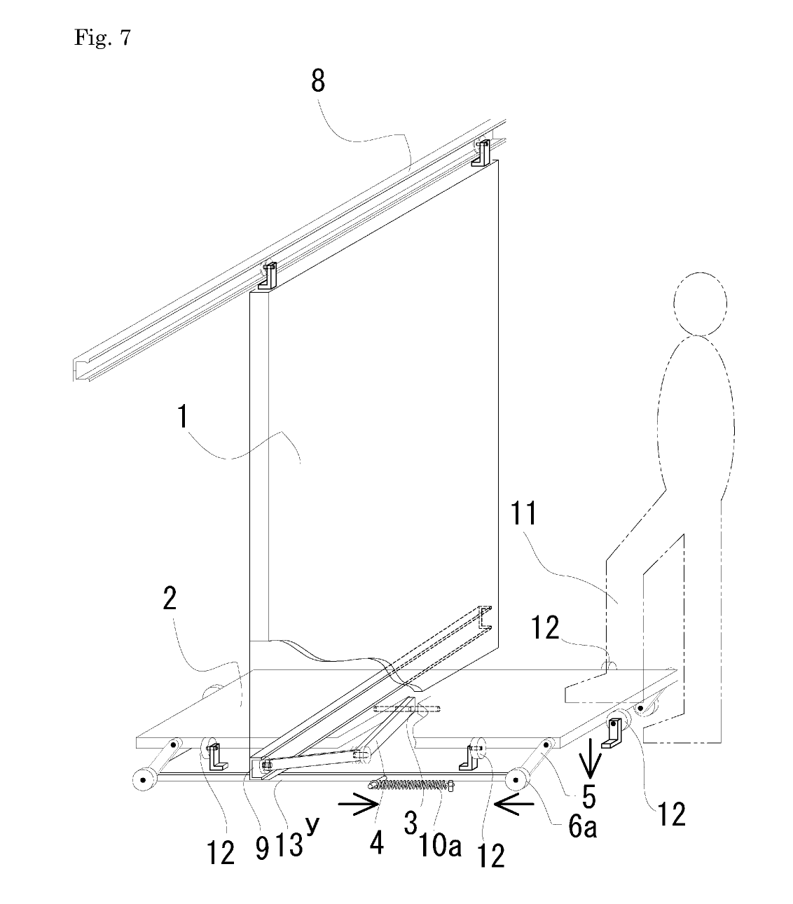

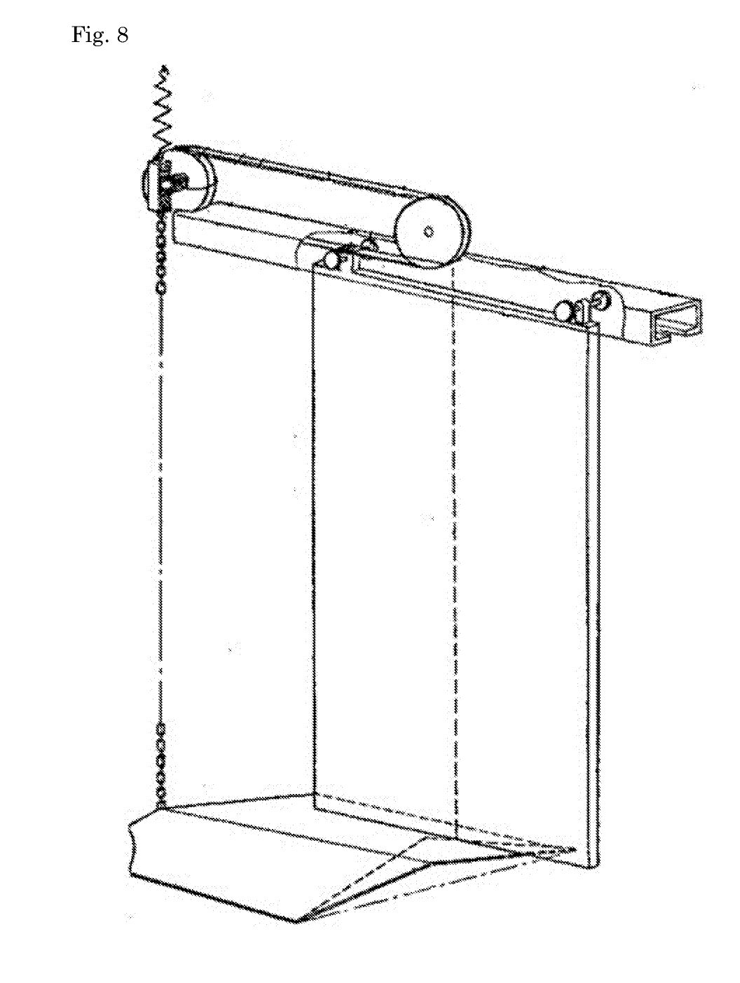

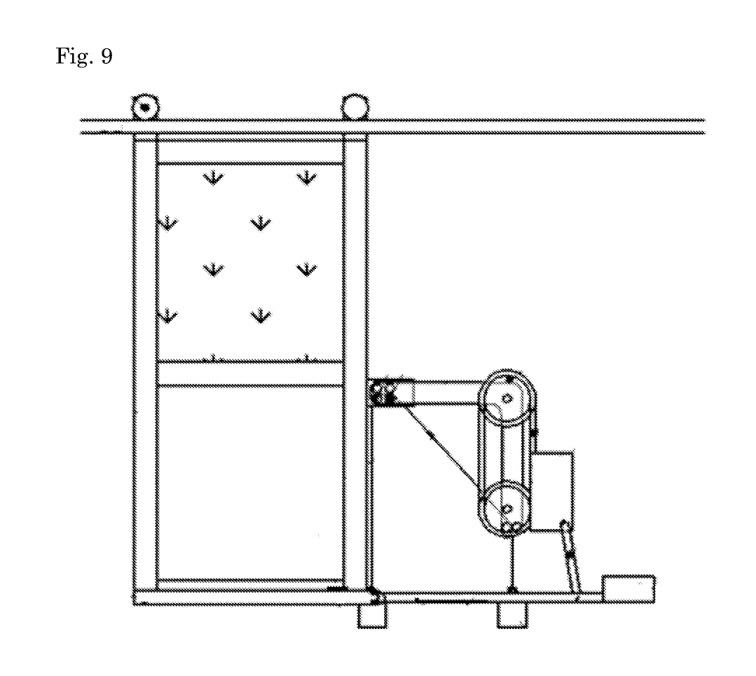

For example, in a door-opening/closing device in which a step plate 2 moves downward and rises with respect to the floor in a straight or arcuate manner as shown in FIGS. 6 and 7, there can be adopted as a return mechanism (1) a configuration such that the weight 7 rises when the step plate 2 moves downward, and then the weight 7 moves downward and causes the step plate 2 to rise after a pedestrian passes; or (2) a configuration that uses a biasing means such as a spring that accumulates biasing force when the step plate 2 moves downward, and then releases the biasing force when the pedestrian steps off the step plate 2, which causes the step plate 2 to rise.

In the door-opening/closing device shown in FIG. 6, a step plate 2 and a connecting bar 13 are coupled by links 5. A bearing 6a is provided in the connecting bar 13. The bearings 6a are rotatable and movable on the surface of the floor. A link extender extends from the link 5 at one end of the step plate 2, and a weight 7 is mounted to the link extender. Guides 12 are disposed around the step plate 2 to guide the step plate 2 upward and downward. When the step plate 2 is stepped on by a pedestrian, it moves downward as guided by the guides 12. By this, the force is transferred to the interlock guide 3, the drive arm 4, and the door-opening/closing mechanism (D). At the same time, the connecting bar 13 is moved horizontally by the rotation of the bearings 6a. The links 5 raises the weight 7, which is mounted to the link extenders, with the bearings 6a of the a metal part fixed on the floor as a fulcrum point. After the pedestrian passes, the downward movement of the weight 7 raises the step plate 2 to its original position.

In the door-opening/closing device shown in FIG. 7, no link extender to which a weight 7 is mounted extends from the link 5, and one end of a coil spring 10a is fixed to the connecting bar 13. The other end of the coil spring 10a is fixed to the floor. When a pedestrian steps on the step plate 2, it moves downward, guided by the guides 12. By this, the force is transferred to the interlock guide 3, the drive arm 4, and the door-opening/closing mechanism (D). At the same time, the connecting bar 13 moves in the direction of the arrow by the rotation of the bearings 6a, which causes the coil spring 10a to be extended. After the pedestrian passes, the retraction of the coil spring 10a raises the step plate 2 to its original position. By these configurations, the same function and effects as the above embodiments can be obtained.

### INDUSTRIAL APPLICABILITY

The present invention's step-plate mechanism for the door-opening/closing device does not use electricity, and is suitable in places where (1) electromagnetic waves would adversely affect human bodies or precision equipment, (2) a lot of water is used and electrical shocks or short circuiting might occur, (3) few pedestrians pass and it is desirable to avoid the need for a source of backup electricity, and (4) many pedestrians holding packages pass by, such as a doorway of a warehouse. Also, this device minimizes the work required to install the device.

### Explanation of Numbers Used

1 door

2 step plate

3 interlock guide

4 drive arm

5 link

6 bearing

6a bearing

7 weight

8 overhung-door rail

9 guide

10 torsion spring

10a coil spring

11 foot of a pedestrian

12 guide

13 connecting bar

S1 step-plate mechanism (Example 1)

S2 step-plate mechanism (Example 2)

D door-opening/closing device

1. A step-plate mechanism for a door-opening/closing device that is powered by the downward movement of a step plate caused by a stepping force of a pedestrian, with the step plate being disposed on a floor at both the front and back of a door as seen by a pedestrian comprising:
a return mechanism is provided to bias the step plate, which moves downward by the stepping force of the pedestrian, to return to its original position after the pedestrian passes.

2. The step-plate mechanism according to claim 1,
wherein the step-plate mechanism further includes step plates having plural bearings;
multiple links, one end of each of which is coupled to one of the bearings of the step plates; and
bearings disposed in a metal part fixed on the floor, with each bearing coupled to the other end of one of the links;
wherein the step plate, while remaining horizontal, moves downward arcuately in the direction in which the pedestrian is walking; and
wherein the return mechanism biases the links, whose angles have been displaced obliquely downward due to the load of a pedestrian, to return to their original angles.

3. The step-plate mechanism according to claim 2,
wherein two step plates are provided, one step plate having an interlock guide, and the other step plate having an interlock-guide-receiving member slidably connected to said interlock guide; and
wherein, when one step plate moves downward in a constant displacement, the other step plate also moves downward in a line-symmetric, constant displacement with the door as a symmetrical axis.

4. The step-plate mechanism according to claim 2,
wherein the return mechanism comprises a link extender in which the other end side of the link is extended in the direction opposite from the step plate, and a weight that is axially supported on the end of the extended part of the link extender; and
wherein the weight rises when a pedestrian steps on the step plate and the step plate moves downward, and, when the pedestrian steps off the step plate, the weight moves downward due to its own weight and causes the step plate to rise.

5. The step-plate mechanism according to claim 1, wherein the return mechanism comprises a bearing mounted to a fixed part of the step plate, and a torsion spring that is mounted, coaxially with one of the bearings, to a shaft disposed in the metal parts; and
wherein the torsion spring accumulates a biasing force when a pedestrian steps on the step plate and the step plate moves downward, and, when the pedestrian steps off the step plate, the torsion spring releases the biasing force, causing the step plate to rise.

6. The step-plate mechanism according to claim 1, wherein the door is an overhung door whose upper end is slidably hung on an overhung-door rail that is inclined downward in either the opening direction or closing direction of the door.
